(19) United States
(12) Patent Application Publication
(10) Pub. No.: US 2009/0005963 A1
(43) Pub. Date: Jan. 1, 2009

(54) Method, Apparatus and Computer Program Product for Providing Route Planning Based on Personal Activity Plans of Multiple Individuals

(75) Inventor: Oula Jarvinen, Espoo (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/769,239

(22) Filed: Jun. 27, 2007

(51) Int. Cl. G01C 21/34

(52) U.S. Cl. 701/201

(57) ABSTRACT

An apparatus for providing improved route planning may include a processing element. The processing element may be configured to receive calendar information from at least one driver and at least one passenger that are each registered to a service having a routing functionality, and determine a transportation plan including a travel route based on the received calendar information.

### FIELD OF THE INVENTION

Embodiments of the present invention relate generally to navigation services and, more particularly, relate to an apparatus, method and a computer program product for providing routing services.

### BACKGROUND OF THE INVENTION

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. Such increased ease of information transfer and convenience to users has recently been accompanied by an increased ability to provide mobile communications at a relatively low cost. Accordingly, mobile communication devices are becoming ubiquitous in the modem world. With the rapid expansion of mobile communications technology, there has been a related rapid expansion in those services that are demanded and provided via mobile communication devices.

One area in which services have recently expanded relates to provision of various applications or software to users of electronic devices such as a mobile terminal. The applications or software may be executed from a local computer, a network server or other network device, or from the mobile terminal such as, for example, a mobile telephone, a mobile television, a mobile gaming system, etc, or even from a combination of the mobile terminal and the network device. In this regard, various applications and software have been developed and continue to be developed in order to give the users robust capabilities to perform tasks, communicate, entertain themselves, etc. in either fixed or mobile environments.

One task which may be performed may relate to navigation services such as services that provide route determination. Such navigation services have been further developed in the form of applications that run on cellular phones, which may track and report the movement of a cellular phone although such applications are also commonly used in vehicles or other mobile platforms. Such applications have been implemented with various location sensing devices and for numerous functions. For example, users may utilize mapping applications to determine an optimal or in some way desirable route from one location to another. The optimization is typically performed on the basis of factors such as time, distance, fuel consumption or other operational considerations.

Due to rising fuel prices, security concerns, traffic congestion and other factors, carpooling and other ride sharing programs have been developed to address the factors above. In this regard, whether applied in a family setting, where it may be desirable to reconcile the different schedules of parents and children, a community setting, where numerous parents manage a few vehicles around the activity schedules of numerous kids, or even in a fleet management setting, the requirements of numerous passengers, drivers and vehicles can become a challenge to manage. Currently, repeated messages and/or phone calls are typically exchanged to enable management of multiple-destination, multiple-passenger route scheduling.

As stated above, applications for use in providing navigation services may be employed to account for traffic and time/distance considerations. However, such services typically have no ability to consider the individual needs of every passenger and/or driver utilizing the service. Although some carpool management applications have been proposed such as, for example, U.S. Patent Application Publication No. 2006/0293937 entitled “System and Method of Wireless Carpool Scheduling,” such applications typically maintain a carpool schedule and receive specific requests for a schedule change. However, due to the requirement to enter each change to the service, management of such an application may become time consuming and/or tedious.

Accordingly, it may be desirable to develop a route planning service that may overcome at least some of the disadvantages described above.

### BRIEF SUMMARY OF THE INVENTION

A method, apparatus and computer program product are therefore provided that may enable the incorporation of the personal activity plans of multiple individuals into route determination. For example, calendar information and/or other personal activity planning information may be utilized for route planning. In an exemplary embodiment, drivers and passengers may register for the service and provide access to their corresponding calendar information via, for example, a calendar or personal activity planning application. Transportation needs of passengers, and availability/capability of drivers, may then be automatically derived from the calendar information and/or other personal activity planning information in order to determine a route that best satisfies the needs of the registered participants. Accordingly, route determination decisions may be made based on calendar information and/or other personal activity planning information of each registered participant.

In one exemplary embodiment, a method of providing an improved transportation planner is provided. The method may include receiving a registration to a service having a routing functionality from registered users including each of at least one driver and at least one passenger, receiving calendar information from the at least one driver and the at least one passenger, and determining a transportation plan including a travel route based on the received calendar information.

In another exemplary embodiment, a computer program product for providing an improved transportation planner is provided. The computer program product may include at least one computer-readable storage medium having computer-readable program code portions stored therein. The computer-readable program code portions may include a first executable portion and a second executable portion. The first executable portion may be for receiving calendar information from at least one driver and at least one passenger that are each registered to a service having a routing functionality. The second executable portion may be for determining a transportation plan including a travel route based on the received calendar information.

In another exemplary embodiment, an apparatus for providing an improved transportation planner is provided. The apparatus may include a processing element. The processing element may be configured to receive calendar information from at least one driver and at least one passenger that are each registered to a service having a routing functionality, and determine a transportation plan including a travel route based on the received calendar information.

In another exemplary embodiment, an apparatus for providing an improved transportation planner is provided. The apparatus includes means for receiving calendar information from at least one driver and at least one passenger that are each registered to a service having a routing functionality, and means for determining a transportation plan including a travel route based on the received calendar information.

Accordingly, embodiments of the present invention may provide improved route planning with a reduced amount of overhead since each individual have their transportation needs/desires considered without being required to specifically request changes to existing route plans. Rather, route planning may be optimized by considering the personal activity planning information of each registered participant automatically by using, for example, the calendar of each participant.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates a block diagram showing a system for providing an improved transportation planner according to an exemplary embodiment of the present invention; and

FIG. 4 is a flowchart according to an exemplary method of providing an improved transportation planner according to an exemplary embodiment of the present invention.

### DETAILED DESCRIPTION OF THE INVENTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

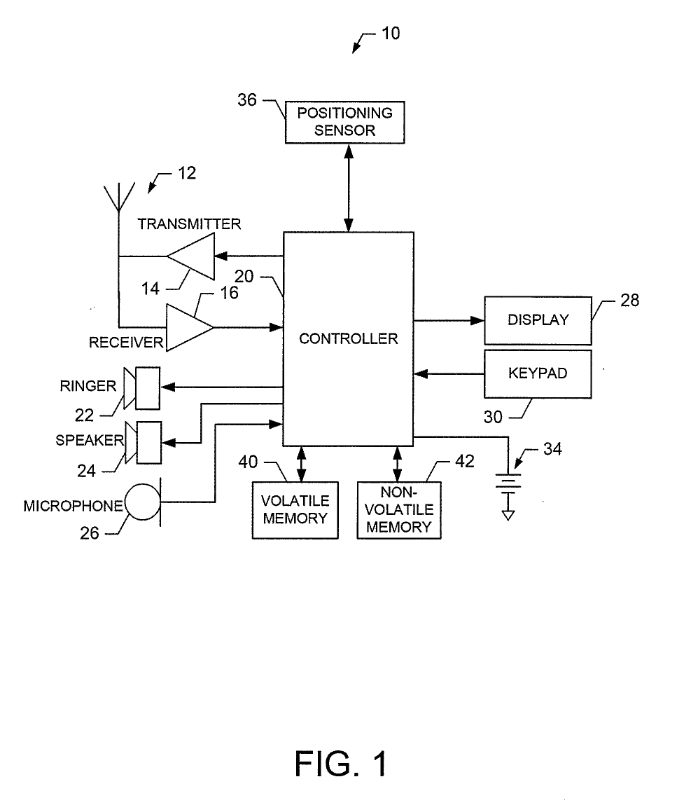

FIG. 1 illustrates a block diagram of a mobile terminal 10 that would benefit from embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While one embodiment of the mobile terminal 10 is illustrated and will be hereinafter described for purposes of example, other types of mobile terminals, such as portable digital assistants (PDAs), pagers, mobile computers, mobile televisions, gaming devices, laptop computers, cameras, video recorders, GPS devices, navigation systems, built-in vehicle devices and other types of voice and text communications systems, can readily employ embodiments of the present invention. Furthermore, devices that are not mobile may also readily employ embodiments of the present invention.

The system and method of embodiments of the present invention will be primarily described below in conjunction with mobile communications applications. However, it should be understood that the system and method of embodiments of the present invention can be utilized in conjunction with a variety of other applications, both in the mobile communications industries and outside of the mobile communications industries.

The mobile terminal 10 includes an antenna 12 (or multiple antennae) in operable communication with a transmitter 14 and a receiver 16. The mobile terminal 10 further includes a controller 20 or other processing element that provides signals to and receives signals from the transmitter 14 and receiver 16, respectively. The signals include signaling information in accordance with the air interface standard of the applicable cellular and/or wireless system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or any other current or future wireless standard. For example, the mobile terminal 10 may be capable of operating in accordance with second-generation (2G) wireless communication protocols IS-136 (TDMA), GSM, and IS-95 (CDMA), or with third-generation (3G) wireless communication protocols, such as UMTS, CDMA2000, WCDMA and TD-SCDMA, with fourth-generation (4G) wireless communication protocols, with a wireless communications protocols of less mobile nature such as Bluetooth, Wireless USB, WLAN/WiFi (IEEE 802.11 family), WiMAX, UltraWideBand, or the like.

It is understood that the controller 20 includes circuitry desirable for implementing logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown), audio input reception system, or other input device. In embodiments including the keypad 30, the keypad 30 may include the conventional numeric (0-9) and related keys (#, *), and other keys used for operating the mobile terminal 10. Alternatively, the keypad 30 may include a conventional QWERTY keypad arrangement, an alphabetical keypad arrangement, any other one-key-per-letter arrangement or an intelligent key arrangement with a reduced number of keys. The keypad 30 may also include various soft keys and virtual touch areas used as keys with associated functions. In addition, or alternatively, the mobile terminal 10 may include an interface device such as a joystick or other user input interface. The mobile terminal 10 further may include a battery 34 or external power source from e.g. a vehicle for powering various circuits that are required to operate the mobile terminal 10, as well as optionally providing mechanical vibration as a detectable output.

In addition, the mobile terminal 10 may include or otherwise be in communication with a positioning sensor 36. The positioning sensor 36 may include, for example, a global positioning system (GPS) sensor, an assisted global positioning system (Assisted-GPS) sensor, Galileo sensor, etc. However, in one exemplary embodiment, the positioning sensor 36 may include a pedometer or inertial sensor. In this regard, the positioning sensor 36 is capable of determining a location of the mobile terminal 10, such as, for example, longitudinal and latitudinal directions of the mobile terminal 10, or a position relative to a reference point such as a destination or start point. Alternatively, the positioning sensor 36 need not be employed by the mobile terminal 10 and location information related to the mobile terminal 10 may be provided using cell id information, triangular positioning, or other mechanisms employed at a network device or at the terminal.

The mobile terminal 10 may further include memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10. Furthermore, the memories may store instructions for determining cell id information. Specifically, the memories may store an application program for execution by the controller 20, which determines an identity of the current cell, i.e., cell id identify or cell id information, with which the mobile terminal 10 is in communication. In conjunction with the positioning sensor 36, the cell id information may be used to more accurately determine a location of the mobile terminal 10.

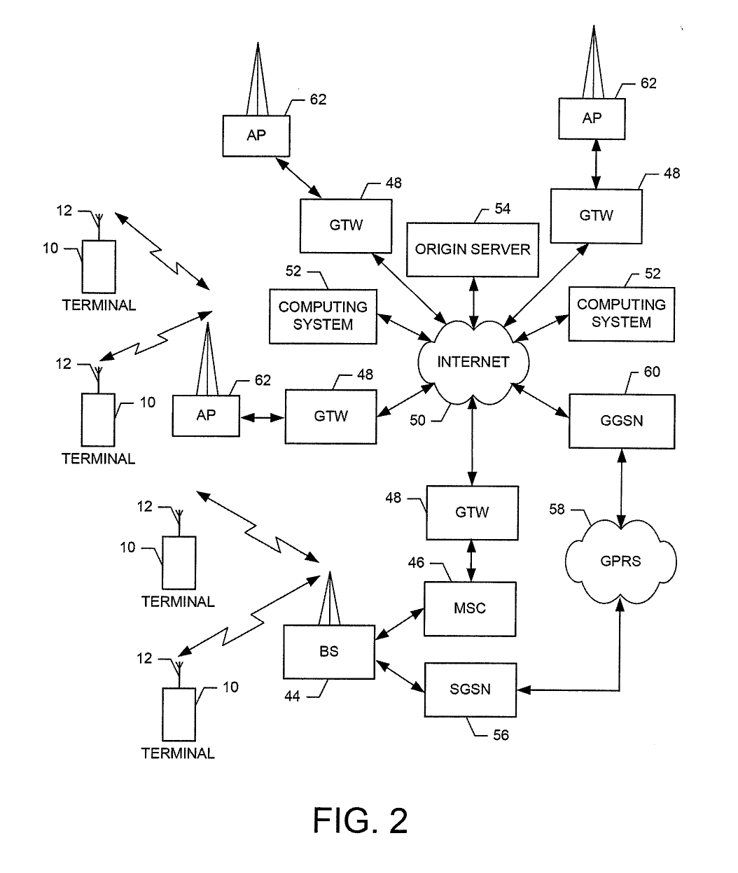

FIG. 2 is a schematic block diagram of a wireless communications system according to an exemplary embodiment of the present invention. Referring now to FIG. 2, an illustration of one type of system that would benefit from embodiments of the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a gateway device (GTW) 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 2), origin server 54 (one shown in FIG. 2) or the like, as described below.

The BS 44 can also be coupled to a Serving GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a gateway GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP) and/or the like, to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) may be capable of supporting communication in accordance with any one or more of a number of first-generation (1G), second-generation (2G), 2.5G, third-generation (3G), 3.9G, fourth-generation (4G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as a Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or wireless Personal Area Network (WPAN) techniques such as IEEE 802.15, BlueTooth (BT), ultra wideband (UWB) and/or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Although not shown in FIG. 2, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX, UWB techniques and/or the like. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX, UWB techniques and/or the like.

In an exemplary embodiment, content or data may be communicated over the system of FIG. 2 between a mobile terminal, which may be similar to the mobile terminal 10 of FIG. 1, and a network device of the system of FIG. 2 in order to, for example, execute applications or establish communication between the mobile terminal 10 and other mobile terminals. As such, it should be understood that the system of FIG. 2 need not be employed for communication between mobile terminals or between a network device and the mobile terminal, but rather FIG. 2 is merely provided for purposes of example. Furthermore, it should be understood that embodiments of the present invention may be resident on a communication device such as the mobile terminal 10, and/or may be resident on a network device or other device accessible to the communication device, or the embodiments may have a split architecture implemented partially in both the mobile terminal 10 and one or more network devices. For example, the mobile terminal 10 may be in communication with a network device such as a server configured to provide route planning and/or optimization services consistent with embodiments of the present invention.

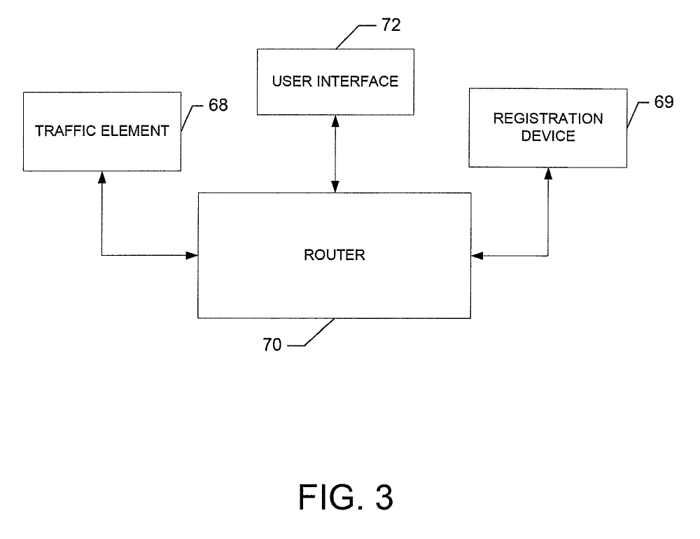

An exemplary embodiment of the invention will now be described with reference to FIG. 3, in which certain elements of a system for providing improved route planning are displayed. The system of FIG. 3 may be employed, for example, on the mobile terminal 10 of FIG. 1 or one or more of the network devices of FIG. 2. However, it should be noted that the system of FIG. 3, may also be employed on a variety of other devices, both mobile and fixed, and therefore, the present invention should not be limited to application on devices such as the mobile terminal 10 of FIG. 1 or the network devices of FIG. 2.

Referring now to FIG. 3, a block diagram of a system for employing an embodiment of the present invention is displayed. As shown in FIG. 3, the system may include a traffic element 68, a registration device 69 and a router 70. However, it should be noted that the traffic element 68 need not necessarily be employed in connection with the registration device 69 and the router 70 in order to practice embodiments of the present invention. As such, the traffic element 68 is provided as an example of a device or element that may add additional functionality to embodiments of the present invention as described in greater detail below. In an exemplary embodiment, a user interface 72 may be in communication with the registration device 69 and/or the router 70.

The user interface 72 may include, for example, the keypad 30 and/or the display 28 and associated hardware and software. In an exemplary embodiment, the user interface may further include voice user interface elements such as a microphone, speaker and/or speech-to-text or text-to-speech transcoding elements. It should be noted that the user interface 72 may alternatively be embodied entirely in software, such as may be the case when a touch screen is employed for interface using functional elements such as software keys accessible via the touch screen using a finger, stylus, etc. As another alternative, the user interface 72 may include a simple key interface including a limited number of function keys, each of which may have no predefined association with any particular text characters. As such, the user interface 72 may be as simple as a display and one or more keys for selecting a highlighted option on the display for use in conjunction with a mechanism for highlighting various menu options on the display prior to selection thereof with the one or more keys. User instructions for the performance of a function may be received via the user interface 72 and/or an output such as by visualization of data may be provided via the user interface 72.

Each of the traffic element 68, the registration device 69 and the router 70 may be any device or means embodied in hardware, software or a combination of hardware and software that is capable of performing the corresponding functions described below. Accordingly, each of the traffic element 68, the registration device 69 and/or the router 70 may be controlled by or otherwise embodied as a processing element (e.g., the controller 20 or a processor of a computer or server. Processing elements such as those described herein may be embodied in many ways. For example, the processing element may be embodied as a processor, a coprocessor, a controller or various other processing means or devices including integrated circuits such as, for example, an ASIC (application specific integrated circuit).

The user interface 72, the traffic element 68, the registration device 69 and the router 70 may be in communication with each other via any wired or wireless connection. In an exemplary embodiment, the user interface 72, the traffic element 68, the router 70 and the registration device 69 may each be embodied at the mobile terminal 10 or at a client device such as a personal computer. However, any of the traffic element 68, the registration device 69 and/or the router 70 may alternatively be embodied at a network device such as a server configured to enable communications with one or more mobile and/or fixed terminals. It should be understood that, in an embodiment where the traffic element 68, the registration device 69 and the router 70 are each embodied as servers, one or more of the traffic element 68, the safety element 69 and the router 70 may be embodied on the same physical server. Alternatively, each of the traffic element 68, the registration device 69 and the router 70 may be embodied on a separate server. As such, whether embodied on servers, mobile terminals or other devices, the traffic element 68, the registration device 69 and the router 70 may be collocated in the same device, or one or more of the traffic element 68, the registration device 69 and the router 70 may be embodied at separate devices.

The traffic element 68 may be configured to receive information defining a particular route (or route segment) between two locations and determine traffic information related to the particular route (or route segment). As an alternative, the traffic element 68 may be configured to determine traffic information for a particular area, independent of any particular route. In either case, for example, the traffic element 68 may be configured to determine traffic information based on image or video data, manually entered reports, statistics gathered by remote sensors, etc. In this regard, the traffic information may be obtained in several ways. For example, traffic information may be obtained using sensors disposed at or even embedded in or near roads or transportation routes. The sensors may be configured to track the number of vehicles or other entities passing by a certain point over time. Thus, traffic information may be determined at particular points along the route or at particular points in a region. Alternatively, traffic information may be obtained using satellite imaging. Thus, satellite imaging data may be utilized to determine traffic information over portions of the route or the region that are covered by satellite imaging devices. As yet another alternative example, traffic information may be determined based on high-end image processing using, for example, closed circuit television (CCTV) cameras or based on movement data regarding vehicles carrying GPS receivers and submitting data over a wireless link. Again, in this example, the traffic information would be provided for those areas of the route or region for which CCTV coverage is provided. Other possibilities for determining the traffic information are also available, including combinations of the examples above and/or other mechanisms. The traffic element 68 may be configured to communicate the traffic information to the router 70 for use in selection or determination of a route as described below.

The traffic element 68 may also be configured to receive other information related to vehicular traffic such as safety and/or environmental information. In this regard, the traffic element 68 may receive safety data from one or more safety or environmental data sources. Each of the safety data sources may provide safety data of any particular safety data type. A safety data type may refer to a class, category, group or set of data that shares a common trait, feature or characteristic. Examples of safety data types may include accident data, airbag deployment data, road characteristic data, vehicular crime rate data, general crime rate data, etc. The safety information may be obtained, received or accessed from one or more sources. In an exemplary embodiment, the safety information may be obtained from one or more databases that may be either periodically, routinely or continuously updated.

The registration device 69 may be configured to receive registration information associated with a plurality of registered users for registering the registered users for a routing service. In other words, the registration device 69 may register participants (i.e., registered users such as drivers and/or passengers) for a transportation service that is configured to determine optimal routing (or at least routing that is acceptable to a maximum number of participants) to the participants based on schedule related information associated with each of the participants. In this regard, the registered users may login or otherwise access the registration device 69 to enter personal information identifying themselves and providing detailed information regarding their personal schedules and/or transportation desires or needs.

In an exemplary embodiment, the registration device 69 may be configured to receive information related to each registered user during the registration of each corresponding registered user. In this regard, the registration device 69 may be in communication with a user interface 72 to receive input from a user attempting to register and to provide visualization of information to the user. The input received from the user may include registration information, which may be provided, for example, by the user via a registration console presenting various fields which the user may fill with corresponding data for registration. For example, the registration console may prompt registering users to register as a particular user type, such as passenger, driver, or both. Registration information may also include identification information such as, for example, home address, telephone number (home, work and/or mobile), email address, etc. In an exemplary embodiment registration information may further include address information for route determination such as work address, pickup and drop off locations such as address information for certain activities (especially those for which travel accommodations may frequently be desired). As such, the registration device 69 may receive information identifying location names and associated addresses so that, for example, given information identifying a particular activity that a registered user is attending, the registration device 69 may be able to determine the location at which the registered user may need to be picked up and/or dropped off in order to facilitate attendance at the particular activity.

Users interested in registering for the service may be referred by existing users or may be offered registration through an advertisement or other solicitation. In this regard, new users and user groups may be invited to register for the service and those accepting a particular invitation may form a corresponding group of registered users.

In an exemplary embodiment, the registration device 69 may also be configured to receive requirement criteria and/or capability criteria associated with each registered user. The requirement criteria may include, for example, vehicle limitations, passenger limitations, or driver limitations. The capability criteria may include information corresponding to a particular vehicle such as vehicle capacity (with respect to storage and/or numbers of passengers), fuel economy, range, type of fuel, communication capability, navigation capability, handicap capability, horsepower, all or four-wheel drive capability, towing capacity, load capacity and the like, or corresponding to a particular driver such as class of drivers license, language skills, first aid skills, etc. Users registering as a driver may be prompted or otherwise have an option to register particular vehicles and any corresponding capability criteria and/or vehicle characteristics or limitations associated with each particular vehicle. Vehicle limitations (or vehicle characteristics) may include times during which the particular vehicle is unavailable for use or out of service (e.g., for maintenance or due to use by a non registered user), areas where the vehicle is allowed or not allowed to be driven, passengers that are allowed or not allowed in the particular vehicle, etc. Passenger limitations (or passenger characteristics) may include curfew times, preferences with regard to vehicle, driver or fellow passengers, walking distance limitations from a pickup or drop off point to an origin or destination, tolerance and/or preferences for supplementing travel plans using public transportation, special needs (e.g., with respect to language, health or disability), accompanying equipment requirements, etc. Driver limitations (or driver characteristics) may include vehicle and/or passenger preferences, periods of unavailability, maximum wait time, areas served, maximum mileage per day/hour, etc. The registration device 69 may be configured to communicate capability criteria, limitation criteria and other registration information to the router 70 to enable the router 70 to determine a transportation plan.

In an exemplary embodiment, the router 70 may be configured to access calendar information associated with each registered user. Calendar information as described herein may be defined as information received from a calendar application or other personal activity planning application. In this regard, for example, calendar information may include one or more individual calendar or otherwise planned events, a schedule for which may be provided in a timeline or list fashion in association with a particular date and/or time. As such, calendar information may be augmented by notification of a single event such as by sending an email, SMS, message or other entry specifically intended to provide notice only of the individual event prompting the notification. However, in one example, calendar information may be further defined or characterized in that it may be information including and/or providing a comprehensive source for a plurality of events, items, occurrences, etc. associated with a particular individual, group, entity, location, or object. According to an exemplary embodiment, the router 70 may be in communication with each registered user's calendar or personal activity planning application. Such communication may be continuous, routine or periodic. For example, synchronization of each registered user's calendar with the router 70 may be at set intervals, or in response to particular events. In this regard, synchronization may be accomplished when a user logs in, when the user makes a schedule change impacting the user's calendar information, when any change is made to a travel plan, or the like.

The calendar information may be provided via communication with an external calendar application (e.g., an Outlook or web based calendar). In this regard, for example, the router 70 may include a plug-in, code or a device providing functionality for filtering or extracting data from the external calendar application to provide such data as the calendar information used in embodiments of the present invention. As such, for example, the router 70 may access the calendar through an API and run the calendar data through a filter to extract the calendar information for use by the router 70. As an alternative, the calendar information could be received from a calendar application associated with the transportation service provided by a system or device employing an embodiment of the present invention.

The router 70 may be configured to determine a transportation plan based on the calendar information and the registration information associated with each registered user. Thus, for example, using calendar information defining times and activities for a particular passenger, the router 70 may access registration information associated with the particular passenger to determine corresponding locations for each of the activities. Alternatively, in some instances the calendar information may also include location information. The router 70 may also access requirement criteria and/or capability criteria associated with the particular passenger to obtain a comprehensive understanding of the particular passenger's travel needs or desires. The router 70 may also access registration and calendar information for other registered passengers and drivers and determine a transportation plan including a travel route based at least on the calendar information (and possibly also based on the requirement criteria and/or capability criteria) of the registered users. In an exemplary embodiment, the driver may have personal business or activities included in the driver's calendar information. As such, the driver's calendar, and thus the transportation plan, may be automatically adjusted based on time criteria or changes in timing associated with the driver's activities (e.g., shop opening/closing times or personal business “bookmarks”) received automatically online or via manual input. Similarly, pickup and/or drop off data can be updated from certain automated sources such as flight, train, boat, bus or other information associated with a web page that may be linked to a calendar entry. Accordingly, if the flight, train, boat, or bus is delayed, the transportation plan may automatically be updated to reflect the delay.

The transportation plan and/or the travel route may be presented or visualized in a plurality of manners. In this regard, the transportation plan and/or the travel route may be vehicle, driver or passenger centric. In other words, the transportation plan and/or the travel route may be presented from the perspective of any or all of the vehicle, the driver or each passenger. In an exemplary embodiment, the transportation plan may include a collection of travel routes associated with, and arranged from the perspective of, each of the registered users. Each travel route may be accessible only to the corresponding registered user with which the travel route is associated. However, registered users may enable others to view their travel routes or, alternatively, all travel routes may be accessible to each other registered user. The transportation plan may therefore be a comprehensive travel plan for all registered users. For example, the transportation plan could be associated with a family, a neighborhood, a business, a service, a geographical area, a group of friends, or unassociated participants, etc. However, the transportation plan could alternatively be for a particular individual or entity and each travel route could be considered a segment of the transportation plan.

In an exemplary embodiment, the travel route for a vehicle may include information arranged from the perspective of the vehicle. For example, the vehicle may be scheduled to be placed in service at a particular time with a particular driver. The particular driver may make a designated number of pickups and drop offs before arriving at a location where another driver takes over. The other driver may then conduct pickups and/or drop offs, which may include the particular driver now acting as a passenger, until a certain time at which the vehicle is placed out of service. Additionally, each of the drivers may call at locations for personal business as defined by the driver's personal calendar or activity plan.

The travel route for a driver may define which vehicle or vehicles the driver may be driving at various times and may include either route guidance information or merely pickup and drop off information associated with various passengers for which the driver may provide transportation services. As such, it should be understood that the travel route need not include actual road guidance information, but may instead merely include a sequence or order of events and/or locations. However, in some embodiments, the travel route may include driving directions and/or real-time route guidance services. Such services may be provided by the router 70 either directly, or via communication with a navigation service (e.g., and in-vehicle navigation service using GPS and/or verbal directions) or an on-line mapping service (e.g., Mapquest or other like services).

Similarly, the travel route for a passenger may define places and times at which the passenger is to be picked up and/or dropped off. The travel route may include other information identifying the vehicle and/or driver associated with each segment of the travel route. Other passengers may also be identified and contact information for both drivers and passengers may also be provided. In an exemplary embodiment, the travel route may also include guidance or instructions related to portions or segments of the travel route that may include public transportation or pedestrian travel.

Accordingly, the router 70 may be configured to map passengers to drivers and/or drivers to passengers to create a transportation plan that may be optimized in terms of a specified characteristic such as drive time, mileage, preferred company, etc., at least in part based on an automatic derivation of events for consideration with respect to generation of the transportation plan from calendar information associated with each registered user. Of note, there is no need (although one may choose to do so) to define closed groups of drivers and/or passengers. Accordingly, an unlimited hash of connections between registrants to the service may be enabled. The transportation plan may include exact meeting places, estimated arrival times, routes, and supplemental information such as additional modes of transportation such as walking or public transportation.

In an exemplary embodiment, when the router 70 determines the transportation plan, the transportation plan (or at least the travel route of the corresponding registered user) may be communicated to each registered user. The communication may be via email, SMS, via an associated dedicated client application practicing an embodiment of the present invention, via a personalized dynamic web page, or any other suitable method. In response to receipt of the transportation plan, each registered user may be enabled to provide feedback regarding the transportation plan. The feedback may be directly to the router 70 or to other registered users. In an exemplary embodiment, the feedback may include an input to accept or decline the travel plan. In response to receiving a decline response from one of the registered users, the router 70 may be configured to determine a new transportation plan based on the decline response. Registered users may also be able to communicate schedule changes to the router 70, either directly or via making changes to their personal calendar application. In either case, the router 70 may be configured to determine a new transportation plan based on the changes made. A new transportation plan may also be determined by the router 70 in response to information from the traffic element 68 indicating, for example, a traffic situation that should be avoided. Feedback may also or alternatively be provided during and/or after execution of the transportation plan. In this regard, the feedback may include rating or satisfaction information regarding the quality and/or accuracy of the service provided. Such feedback may be considered for future transportation plan determination and/or priority assignment. The feedback may be manually gathered or automatically gathered (e.g., based on GPS and/or vehicle systems information).

In an exemplary embodiment, the router 70 may be further configured to provide real-time updates with respect to progress along the travel route to any or all of the registered users. For example, if a passenger is expecting to be picked up at a particular time, the passenger may be able to check the current location of the driver and determine whether the driver is likely to be on time based on the driver's current progress. In this regard, the router 70 may further include a notification function to alert registered users (e.g., via SMS, email alert, phone call, alarm, etc.), in cases where it is determined that a particular driver or vehicle has deviated from the transportation plan by a predetermined amount. In response to a determination that the transportation plan has deviated, the router 70 may also be configured to re-determine the transportation plan and provide the registered users with updated information regarding the transportation plan.

The router 70 may also be configured to provide registered users with activity reports based on recent activities of the corresponding registered users. Such reports may be useful for cost sharing purposes by enabling participants to realize relative contributions of various participants or costs incurred by various participants. As such, passengers may share fuel and/or mileage costs with drivers in a predetermined way such as by bearing a percentage of the costs incurred by the driver. In one example, embodiments of the present invention may be utilized in connection with a commercial service in which transportation can be arranged on a fee basis. However, unlike conventional taxi services, embodiments of the present invention may operate by enabling registered passengers to arrange service by sharing calendar information with a registered driver. In this regard, for example, either all or a portion of the registered passengers' calendar information may be shared in order to arrange a ride. For example, a passenger may share the passenger's entire calendar and the service may determine transportation for applicable activities for which to arrange transportation based on registration information. Alternatively, a passenger may select an option associated with an item of the passenger's calendar to submit the item to the service for the arrangement of transportation. In either case, the passenger may be billed for the transportation provided based on a billing arrangement agreed to during registration.

Accordingly, a system such as has been described herein may be useful in connection with organizing and optimizing travel plans amongst individuals or groups such that the input and desires of each of the individuals may be considered. Moreover, in an exemplary embodiment, the router 70 may be able to resolve conflicts with regard to determination of the transportation plan based on priority information. In this regard, for example, each registered user may assign priority ratings to individual activities, or predefined rules may establish priority amongst various passengers and/or drivers. For example, the driver may have first priority and passengers may have secondary priorities. Conflicts may then be resolved by the router 70 on the basis of the corresponding priority associated with a particular registered user and/or activity. Priority may also be based on the historical usage data of the system such as most active users having highest priority.

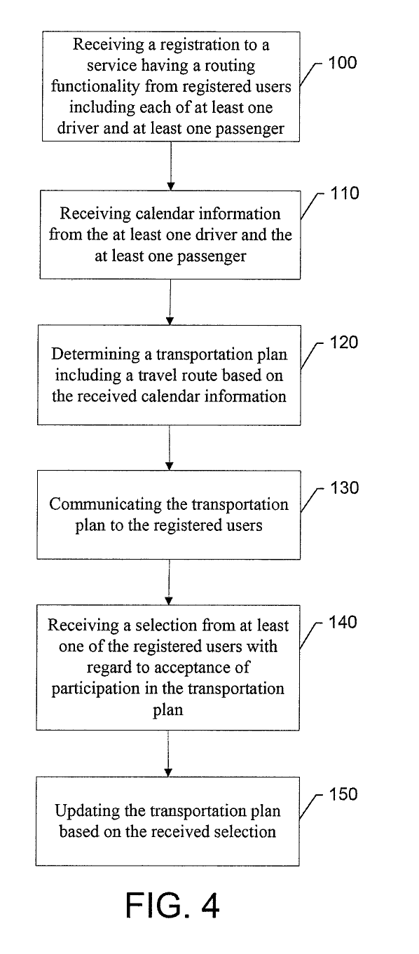

FIG. 4 is a flowchart of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal or server and executed by a built-in processor in the mobile terminal or server. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method for providing an improved transportation planner may include receiving a registration to a routing service (i.e., a service, whether stand alone or federated, having a routing functionality) from registered users including each of at least one driver and at least one passenger at operation 100. At operation 110, calendar information may be received from the at least one driver and the at least one passenger. A transportation plan including a travel route may be determined based on the received calendar information at operation 120. In an exemplary embodiment, the method may further include communicating the transportation plan and related guidance to the registered users at operation 130 and receiving a selection from at least one of the registered users with regard to acceptance of participation in the transportation plan at operation 140. The transportation plan may be updated based on the received selection at operation 150. As alternative operations, exemplary embodiments may include receiving traffic information, requirement criteria and/or capability criteria from at least one of the registered users and the transportation plan may be determined in consideration of any or all of the received traffic information, requirement criteria and capability criteria.

The above described functions may be carried out in many ways. For example, any suitable means for carrying out each of the functions described above may be employed to carry out the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
receiving calendar information from at least one driver and at least one passenger that are each registered to a service having a routing functionality; and
determining a transportation plan including a travel route based on the received calendar information.

2. The method of claim 1, further comprising communicating the transportation plan to the registered users.

3. The method of claim 2, further comprising communicating guidance related to the transportation plan to the registered users.

4. The method of claim 2, further comprising receiving a selection from at least one of the registered users with regard to acceptance of participation in the transportation plan.

5. The method of claim 4, further comprising updating the transportation plan based on the received selection.

6. The method of claim 1, further comprising receiving traffic information and determining the transportation plan based also on the received traffic information.

7. The method of claim 1, further comprising receiving requirement criteria from at least one of the registered users.

8. The method of claim 7, wherein determining the transportation plan further comprises determining the transportation plan based on the received calendar information and the received requirement criteria.

9. The method of claim 7, wherein receiving the requirement criteria further comprises receiving vehicle characteristics, passenger characteristics, or driver characteristics.

10. The method of claim 1, further comprising providing real-time updates with respect to progress along the travel route to at least one of the registered users.

11. The method of claim 1, further comprising receiving capability criteria with respect to at least one of the registered users and wherein determining the transportation plan further comprises determining the transportation plan based on the received capability criteria.

12. The method of claim 1, further comprising resolving conflicts with regard to determination of the transportation plan based on priority information.

13. A computer program product comprising at least one computer-readable storage medium having computer-readable program code portions stored therein, the computer-readable program code portions comprising:
a first executable portion for receiving calendar information from at least one driver and at least one passenger that are each registered to a service having a routing functionality; and
a second executable portion for determining a transportation plan including a travel route based on the received calendar information.

14. The computer program product of claim 13, further comprising a third executable portion for communicating the transportation plan to the registered users.

15. The computer program product of claim 14, further comprising a fourth executable portion for communicating guidance related to the transportation plan to the registered users.

16. The computer program product of claim 14, further comprising a fourth executable portion for receiving a selection from at least one of the registered users with regard to acceptance of participation in the transportation plan.

17. The computer program product of claim 16, further comprising a fifth executable portion for updating the transportation plan based on the received selection.

18. The computer program product of claim 13, further comprising a third executable portion for receiving traffic information and determining the transportation plan based also on the received traffic information.

19. The computer program product of claim 13, further comprising a third executable portion for receiving requirement criteria from at least one of the registered users.

20. The computer program product of claim 19, wherein the second executable portion includes instructions for determining the transportation plan based on the received calendar information and the received requirement criteria.

21. The computer program product of claim 19, wherein the third executable portion includes instructions for receiving the requirement criteria further comprises receiving vehicle characteristics, passenger characteristics, or driver characteristics.

22. The computer program product of claim 13, further comprising a third executable portion for providing real-time updates with respect to progress along the travel route to at least one of the registered users.

23. The computer program product of claim 13, further comprising a third executable portion for receiving capability criteria with respect to at least one of the registered users and wherein the third executable portion includes instructions for determining the transportation plan based on the received capability criteria.

24. The computer program product of claim 13, further comprising a third executable portion for resolving conflicts with regard to determination of the transportation plan based on priority information.

25. The computer program product of claim 24, further comprising a fourth executable portion for generating priority information from a set of defined criteria.

26. An apparatus comprising a processing element configured to:
receive calendar information from at least one driver and at least one passenger that are each registered to a service having a routing functionality; and
determine a transportation plan including a travel route based on the received calendar information.

27. The apparatus of claim 26, wherein the processing element is further configured to communicate the transportation plan to the registered users.

28. The apparatus of claim 27, wherein the processing element is further configured to communicate guidance related to the transportation plan to the registered users.

29. The apparatus of claim 27, wherein the processing element is further configured to receive a selection from at least one of the registered users with regard to acceptance of participation in the transportation plan.

30. The apparatus of claim 29, wherein the processing element is further configured to update the transportation plan based on the received selection.

31. The apparatus of claim 26, wherein the processing element is further configured to receive traffic information and determine the transportation plan based also on the received traffic information.

32. The apparatus of claim 26, wherein the processing element is further configured to receive requirement criteria from at least one of the registered users.

33. The apparatus of claim 26, wherein the processing element is further configured to determine the transportation plan based on the received calendar information and the received requirement criteria.

34. The apparatus of claim 26, wherein the processing element is further configured to receive the requirement criteria by receiving vehicle characteristics, passenger characteristics, or driver characteristics.

35. The apparatus of claim 26, wherein the processing element is further configured to provide real-time updates with respect to progress along the travel route to at least one of the registered users.

36. The apparatus of claim 26, wherein the processing element is further configured to receive capability criteria with respect to at least one of the registered users and to determine the transportation plan based on the received capability criteria.

37. The apparatus of claim 26, wherein the processing element is further configured to resolve conflicts with regard to determination of the transportation plan based on priority information.

38. An apparatus comprising:
means for receiving calendar information from at least one driver and at least one passenger that are each registered to a service having a routing functionality; and
means for determining a transportation plan including a travel route based on the received calendar information.

39. The apparatus of claim 38, further comprising means for communicating the transportation plan to the registered users.
